(19) United States
(12) Patent Application Publication
(10) Pub. No.: US 2015/0144460 A1
(43) Pub. Date: May 28, 2015

(54) VERTICAL RAFT CONVEYOR

(71) Applicants: Mark Pinter, Houston, TX (US); Randall A. Pinter, Houston, TX (US); Samuel Faber, Houston, TX (US)

(72) Inventors: Mark Pinter, Houston, TX (US); Randall A. Pinter, Houston, TX (US); Samuel Faber, Houston, TX (US)

(73) Assignee: TSM Houston, Inc., Houston, TX (US)

(21) Appl. No.: 14/403,245

(22) PCT Filed: May 25, 2012
(86) PCT No.: PCT/US2012/039604

§ 371 Date: Feb. 9, 2015

(51) Int. Cl. B65G 17/26; B65G 43/08; B65G 37/00

(52) U.S. Cl. CPC B65G 17/26; B65G 37/00; B65G 43/08
USPC 198/597; 198/620

(57) ABSTRACT

This invention relates generally to the transport of objects, especially inflatable, semi-rigid, and rigid rafts on a conveyor along an essentially vertical travel path or use at waterpark amusement rides. The invention provides a drive and a plurality of spaced bands each having flights for supporting the raft in an essentially horizontal position.

### FIELD OF THE INVENTION

This invention refers to the transport of objects, especially inflatable, semi-rigid, and rigid rafts on a conveyor along an essentially vertical travel path.

### BACKGROUND

Waterpark amusements have been popular for decades. For a typical waterslide, a rider climbs a stairwell located in a tower, enters an entrance to the waterslide and is propelled by gravity along the waterslide until splashing into a pool located at an end of the waterslide. In certain types of water rides used in waterparks, rafts carrying the riders are passed through flumes to the pool and then the rafts are returned to the top of the flume for repeating the cycle.

The rafts may be of different materials, and of different shapes, sizes, and capacities. They may be inflatable, semi-rigid, or rigid. A persistent problem has been finding satisfactory solutions for returning the rafts to the start of the ride. Many waterparks require the rider to carry the floatation device from the exit of the ride back to the start. The walk back to the start of a ride may be particularly arduous, especially in the case of tall towers or under windy conditions where the rider must control the raft during their climb to the top of the tower. In addition, since waterslides capable of transporting multiple riders at a time have become increasingly popular, the necessarily larger rafts make it even more impractical for riders to carry their raft to the start of the ride.

Accordingly, differing forms of mechanical transportation have been devised to transport the rafts from the exit to the entrance of the ride. A typically deployment uses ramped or angled conveyors comprised of continuous belts or rollers for raising the rafts from the pool proximate the exit of the ride to the start of the ride. The roller type transports typically use a driving chain that engages a drive element on the bottom of the raft or boat. In some cases the rafts are loaded with riders prior to their elevation to the top of the ride, thereby also eliminating the need for the rider to climb the stairs of the tower.

Problems arise with these designs, however, and vary from case to case. Principally, the sloped and angled conveyors require a great deal of space to accommodate the angle of ascent. This requires ride designers to custom build the ride in such a way that it is adapted to local conditions of terrain and space availability. In addition, limitations on available space will constrain the height of the ride for some locations, thereby shortening the potential length of the ride and limiting the enjoyment for the riders.

### SUMMARY OF THE INVENTION

A first aspect of the present invention provides for a conveyor for vertically transporting rafts used for waterslides, comprising a drive connected to a plurality of bands, the bands having a plurality of flights, wherein the plurality of bands are spaced apart and oriented so that at least one flight on each of the plurality of bands is oriented to demountably engage with the raft and maintain a substantially horizontal orientation for the raft throughout its vertical travel path.

The vertical conveyor may include one or more controllers and one or more sensors for sensing the disposition of one or more rafts. The controller may be adapted to control the speed or direction of the vertical conveyor based upon the status of the system.

The vertical conveyor may also comprise an unloader aligned with the vertical conveyor for the substantially horizontal translation of the raft at the top of it vertical travel path.

In a further aspect of the present invention, the vertical conveyor comprises one or more tensioners connected to one or more of the bands that function with weights operating under the force of gravity. The tensioners are configured to permit temporary vertical deflection of one or more of the plurality of the bands.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a elevation view of one embodiment of a vertical conveyor formed in accordance with the present invention, and also showing a loading conveyor assembly and an unloader;

FIG. 2 is an elevation view of the vertical conveyor depicted in FIG. 1 showing both a loading conveyor assembly, and an unloader;

FIG. 3 is a top plan of the of the vertical conveyor shown in FIG. 1;

FIG. 4 is a partial view of an elevation of the vertical conveyor shown in FIG. 1, showing a tensioner in accordance with the present invention;

FIG. 5 is a detail view showing a raft, bands and flights in normal operation;

FIG. 6 is a detail view showing an alternate embodiment of a raft, bands and flights in accordance with the present invention in normal operation;

FIG. 7 is a detail view showing an alternate embodiment of a raft, bands and flights in accordance with the present invention in a jammed situation;

FIG. 8 is partial view of an elevation of the vertical conveyor shown in FIG. 1, showing an unloader in accordance with the present invention;

FIG. 9 is an elevation view showing one embodiment for loading the vertical conveyor of FIG. 1;

FIG. 10 is an elevation view showing a second embodiment for loading the vertical conveyor of FIG. 1;

FIG. 11 is elevation view of an alternate embodiment of a vertical conveyor formed in accordance with the present invention, showing a cover; and

FIG. 12 is an alternate elevation view of the alternate embodiment shown in FIG. 11 showing a cover.

### DETAILED DESCRIPTION OF THE INVENTION

In describing the components of the vertical conveyor and alternative versions or embodiments, of some of these components, the same reference number may be used for elements that are the same as, or similar to, elements described in other versions or embodiments.

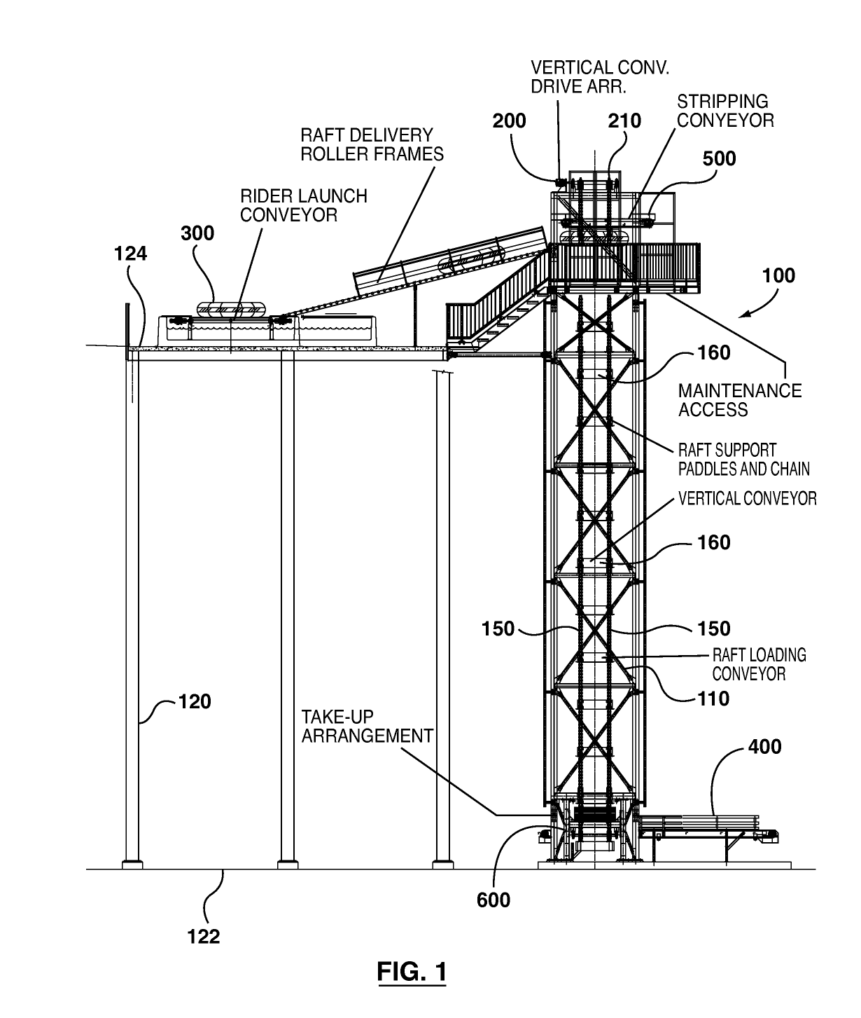

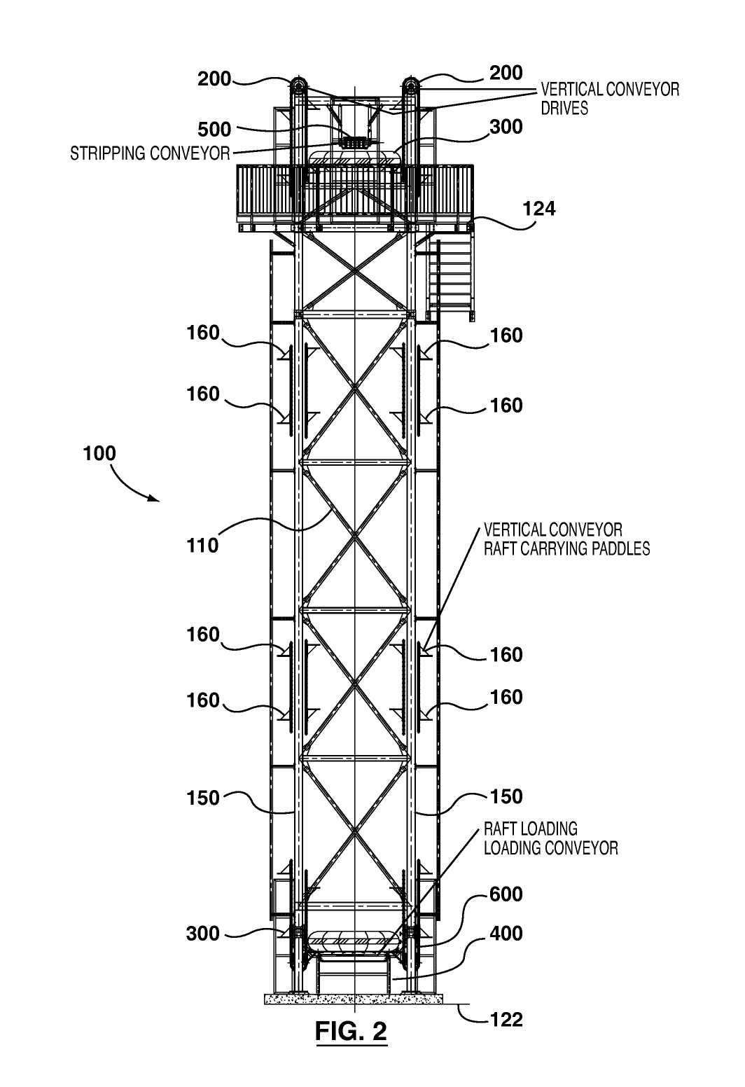

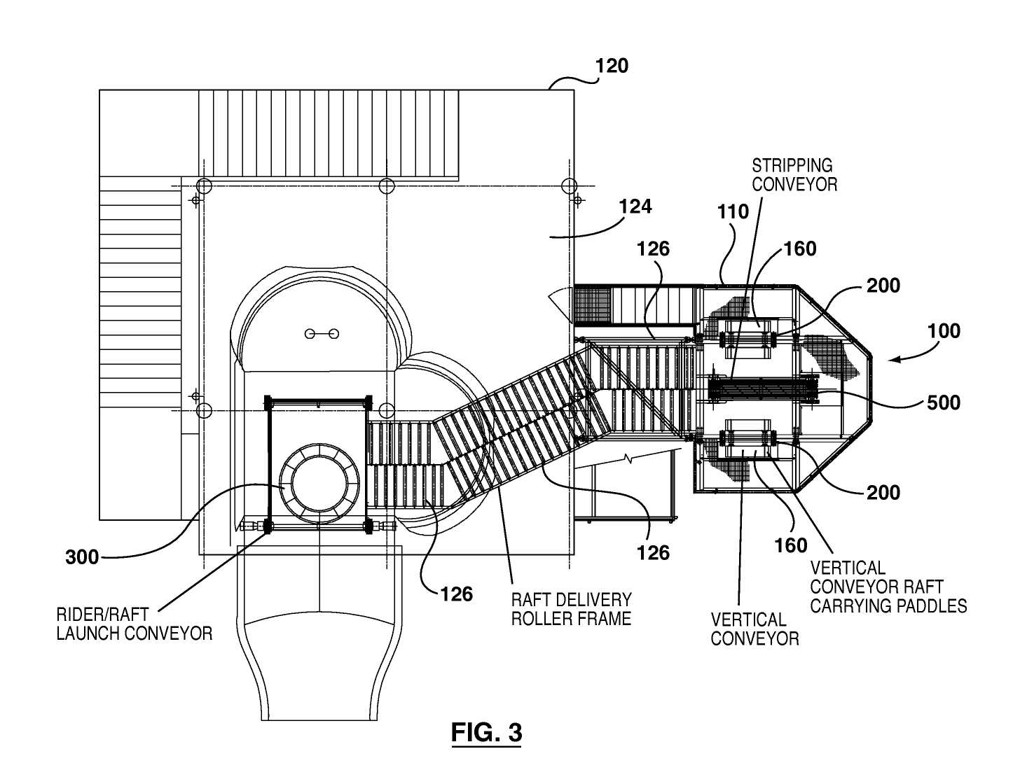

Referring to FIGS. 1-3, there is generally shown a vertical conveyor 100 formed in accordance with the present invention. Construction of the vertical conveyor comprises a metal structure 110 that is common to tower construction, which supports the elements required to transport objects, especially inflatable, semi-rigid or rigid approximately circular or oval rafts 300, such as used for water rides in amusement parks, from the bottom of a waterpark tower 120 to the top of the waterpark tower 120 and the start of the ride.

The system comprises at least one drive 200 to power the transport of the rafts 300 and a plurality of bands 150 connected to the drive 200 by sprockets 210. The at least one drive 200 is configured to ensure that the plurality of bands 150 move at a common speed and in synchronicity. This may be accomplished through any mechanical or control means, and will be appreciated by those skilled in the art. It is advantageous that the drive 200 be selected so that the speed of the plurality of bands 150 may be selected and adjusted, either automatically according to the operation or status of the vertical conveyor 100, or manually under the control of a ride operator.

Spaced on each of the plurality of bands 150 are flights 160 which will be described in more detail below. The flights 160 are spaced along each of the plurality of bands 150 so that the flight 160 on each band 150 is aligned in a horizontal plane during the synchronous vertical movement of the plurality of bands 150. The metal structure 110 is configured so that the plurality of bands 150 are spaced to accommodate the loading of the rafts 300 while the flights 160 are not vertically aligned with the loading point of the raft 300, and the flights 160 demountably engage the raft 300 during the vertical travel of the plurality of bands 150.

As described, the vertical conveyor 100 cooperates and is typically connected to a waterpark tower 120 for the transport of rafts 300 from a level proximate the ground 122 to the top 124 of the tower 120. The vertical conveyor 100 can be designed and supplied for any height tower 120, with various options for achieving the loading and unloading process. Additional components typically assist with the operation of the vertical conveyor 100 to facilitate the loading, unloading and handling of the rafts 300. Such features will be understood by those familiar to waterpark design, but comprise elements such as delivery trays 126. The delivery trays 126 may be comprised of various types of commonly appreciated elements for transporting rafts, such as bands, rollers, or other transporting elements. It has been found advantageous that the delivery tray 126 be fabricated from stainless steel and supplied with conveyor rollers with spring loaded mounting, and stainless steel bearings.

A particularly advantageous embodiment of the vertical conveyor 100 in accordance with the current invention includes an unloader 500 which will be described in more detail below. The unloader 500 operates to unload the rafts 300 from the vertical conveyor 100 and translate the raft's 300 vertical motion into horizontal motion, wherein the raft is delivered to the top 124 of the tower 120, and the start of the ride by means such as one or more delivery trays 126 or otherwise. Alternatively, the rafts 300 may be unloaded manually.

The exemplary embodiment of the vertical conveyor 100 shown in FIGS. 1-3 is shown having four bands 150 powered by two drives 200 with flights 160 to support the raft 300 in four locations. The vertical conveyor 100 delivers the rafts to the top 124 of the tower 120 and automatically unloads the rafts 300 using an unloader 500 on to a delivery tray 126 ready for the riders. Also shown are tensioners 600 associated with each of the bands 150 and an optional raft loader 400. Also included in the preferred embodiment but not show are a controller and at least one sensor for monitoring and controlling the operation of the vertical conveyor 100. Each of these elements will now be discussed in greater detail.

The vertical conveyor 100 may be adapted to accommodate any type of raft 300, which may be of different materials, and of different shapes, sizes, and capacities. They may be inflatable, semi-rigid, or rigid. The typical raft 300 comprises an inflatable portion for providing a rider a flexible, cushioning barrier between the rider and the waterslide. The preferred embodiment handles a circular inflatable raft approximately 1700 mm in diameter, 355 mm high and weighing approximately 13.6 Kg. The device can handle other round or rectangular rafts up to a weight of about 68 Kg without modification. Further it could be modified to handle a variety or shaped rafts or rigid boats.

The drive 200 for the vertical conveyor 100 in the preferred embodiment is hydraulic, but it may also be electric. If the drive 200 is electric it is preferentially adapted for operation in wet environments. In both cases the drive 200 is reversible allowing the direction of the bands 150 to be moved selectively to either raise or lower the rafts 300. This is accomplished by a providing a reversing motor starter if using electric drives, or by hydraulic valves enabling the bands 150 to run in reverse. The advantage of a reversible drive 200 allows the convenient clearing of any jamming of the rafts at the unloading, or upper level of the tower 120.

If the drive 200 is electric, it is preferably of a Variable Frequency Drive (VFD) variety. The VFD is preferably sized for multiple starts with a 5 to 1 reduction. The VFD will be able to provide an adjustable speed for the equipment between 50% to 120% of operating speed; this will enable the ride operator or designer to choose the optimum speed for the loading conditions.

The vertical conveyor 100 may be adapted to deliver rafts 300 at any desired rate. The desired rate will be dependent on the loading and the clearing of the rafts 300 at the pool level and/or at the start of the ride. For example, if it takes approximately 3-4 seconds to unload a raft 300, and approximately 6 seconds to place the next raft into the loading position, the rafts 300 may be delivered at 10-second intervals. The flights 160 may then be spaced accordingly for a given designed travel speeds for the bands 150.

Advantageously, there is a single reducer drive arrangement between the drives and the plurality of bands 150 to ensure that all the bands 150 are travelling at the same speed. Typically, one or more driven pulleys, or most advantageously sprockets 210, are coupled to the drive 200 to selectively drive the plurality of bands 150 and thus propel the rafts 300 along their vertical path. Preferentially, the bands 150 may be confined in low friction guides, and since the band is driven by sprockets 210, conventional band slip is eliminated; therefore the flights will remain in a synchronous position at all times.

Focusing on the bands 150, each band 150 is disposed about one or more sprockets 210 in an endless loop arrangement. A tensioner 600, which will be described below, is preferably provided to tension each band 150. The exemplary vertical conveyor 100 comprises of 4 bands 150 with flights 160 that support the raft in four locations. Supporting the raft in four locations provides a stable platform to keep the raft secured from the loading point to the discharge point at the top of the tower 120, and the synchronous travel of the flights 160 mean the rafts 300 traverse their vertical travel path in an essentially horizontal orientation. It will be appreciated, however, that the vertical conveyor 100 may be adapted to transport the rafts 300 in any other orientation without deviating from the scope of the present invention.

The bands 150 may be manufactured from many forms of continuous material such as rubber, or assemblies of components. In the exemplary embodiment, the bands 150 are chains. In alternate embodiments, the bands 150 may comprise plastic modular elements that are connected to each other to form a continuous loop or belt. Because they do not corrode, are light weight, and are easy to clean, unlike metal conveyor belts, plastic conveyor belts are used widely in hostile or wet environments. Modular plastic conveyor belts are made up of molded plastic modular links, or belt modules, that can be arranged side by side in rows of selectable width. A series of spaced apart link ends extending from each side of the modules include aligned apertures to accommodate a pivot rod. The link ends along one end of a row of modules are interconnected with the link ends of an adjacent row. A pivot rod journaled in the aligned apertures of the side-by-side and end-to-end connected modules forms a hinge between adjacent rows. Rows of belt modules are then connected together to form an endless conveyor belt capable of articulating about a drive sprocket. Modular belts are typically made out of thermoplastic materials such as polypropylene, polyacetal, and polyethylene.

In the exemplary embodiment, the bands 150 are chains, and are well understood in the art. In the case of alternate embodiments incorporating modular belts as the bands 150, they are preferably manufactured from polypropylene, which is chemically resistant, harder, and more durable than some other materials such a rubber. Advantageously, the bands 150 and flights 160 can be easily repaired or replaced with minimum down time or expense. Small sections can be quickly replaced if unforeseen mechanical damage occurs. A collection of spare parts can also be kept locally for rapid repair and minimum downtime for the ride.

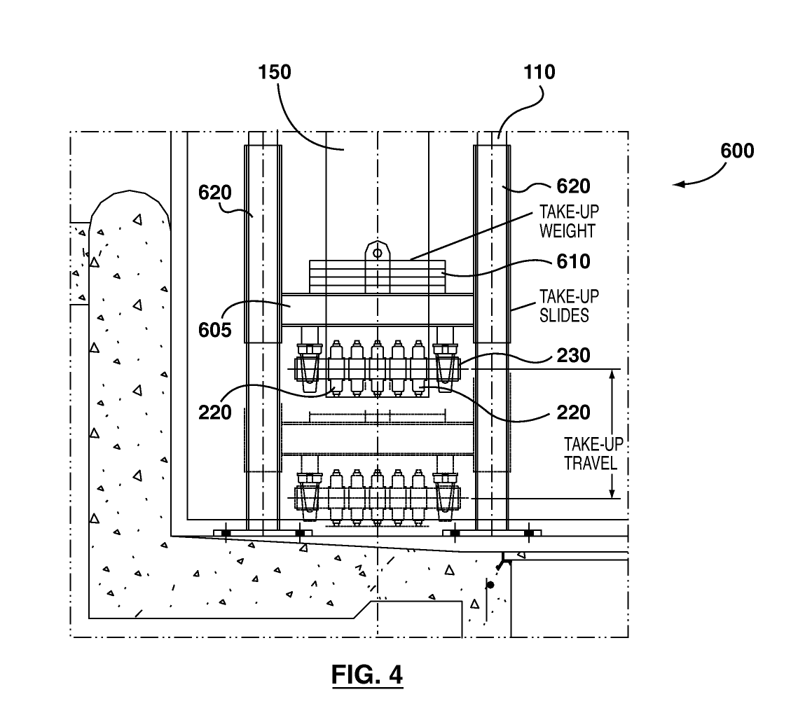

The exemplary embodiment of the vertical conveyor 100 further comprises a tensioner 600 connected to each of the bands 150. Referring to FIG. 4, there is shown an advantageous design for the tensioner 600 associated with one of the bands 150. The preferred embodiment uses an adjustable gravity type counterweight, which provides a uniform and consistent tension to the band 150 and drive sprocket 210 engagements. The tensioner 600 comprises a support structure 605. Coupled to the support structure 605 is an axis 230 on which a plurality of follower sprockets 220 are rotatably mounted. These follower sprockets 220 engage with cooperating elements of the band 150. Also connected to the support structure 605 are guides 620 that are adapted to engage with portions of the metal structure 110. This ensures a tensioner 600 travels only vertically, and therefore retains its associated band 150 in vertical alignment with that band's 150 drive sprockets 210. Then, connected to the support structure 605 is a weight 610 selected to provide sufficient force, under the effect of gravity to maintain tension in the band 150. As the bands 150 are preferably sprocket driven, and in conjunction with the tensioner 600 arrangement, the bands 150 will not slip at the drive sprockets 210 thus ensuring the synchronization of all bands 150 and therefore the flights 160.

In operation, the tensioner is allowed to float. In the event of a jam in the vertical conveyor 100 or shock on the band 150, the tensioner is able to displace in a vertical direction thereby avoiding damage to the bands 150 and/or the rafts 300. A compact gravity tensioner 600 as disclosed provides uniform tension to the bands 150, provides constant tension while in its operating range, and requires very little maintenance. Further, the tensioner 600 can be easily accessed at ground level, and raised to allow for easy repair and maintenance of the band 150

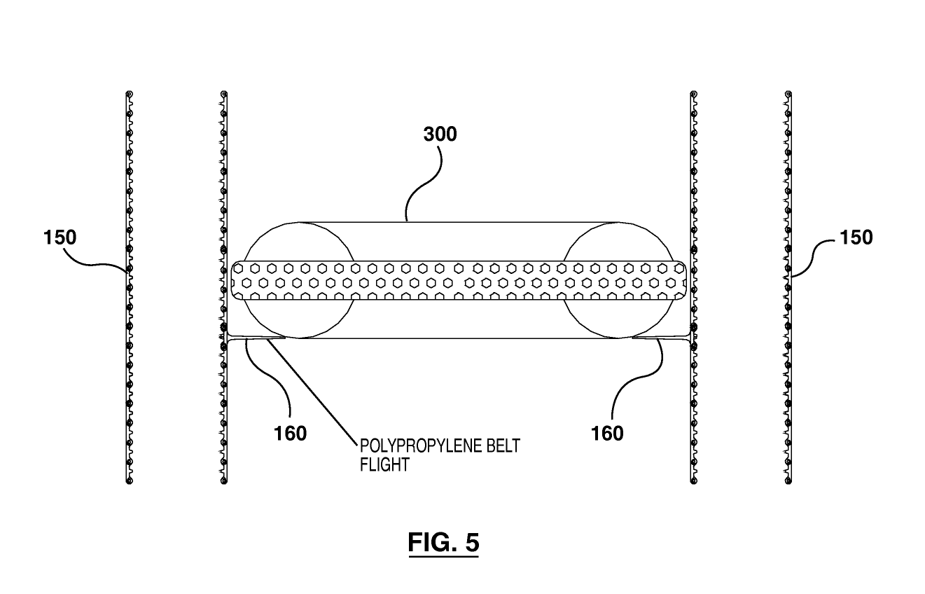

Focusing now on the flights 160, reference is made to FIG. 5 for a more detailed view. Shown are two bands 150 in continuous loops spaced apart to accommodate a raft 300. Connected to each of the bands 150 are flights 160 for demountably engaging the raft 300 and supporting the raft 300 in an substantially horizontal orientation.

The flights 160 may be made from any material suitable for supporting the weight of the rafts 300. The flights 160 may also be either made of flexible material or a rigid material, or hinged against a preloaded spring to allow them to pass by a jammed raft without damaging it.

In the preferred embodiment, the flights 160 are composed of rigid aluminum, but could be composed of one or more substances such as stainless steel or hard rubber, and are free from sharp edges to avoid damaging the rafts 300. The flights 160 may be mounted to the bands 150 by any conventional means that will support the weight of the rafts 300. For instance, the flights 160 may be mechanical fixed in the case where the bands 150 are chain, or in the case where the bands 150 are modular plastic belts the flights 160 may be integral to the band 150. In this latter case, the flights 160 may be adapted to mate with the individual band elements and be affixed using a similar pivot rod. Since the flights 160 would be an integral part of the band 150, the fights can easily be moved and or replaced with little effort without affecting the integrity of the band 150 or its performance.

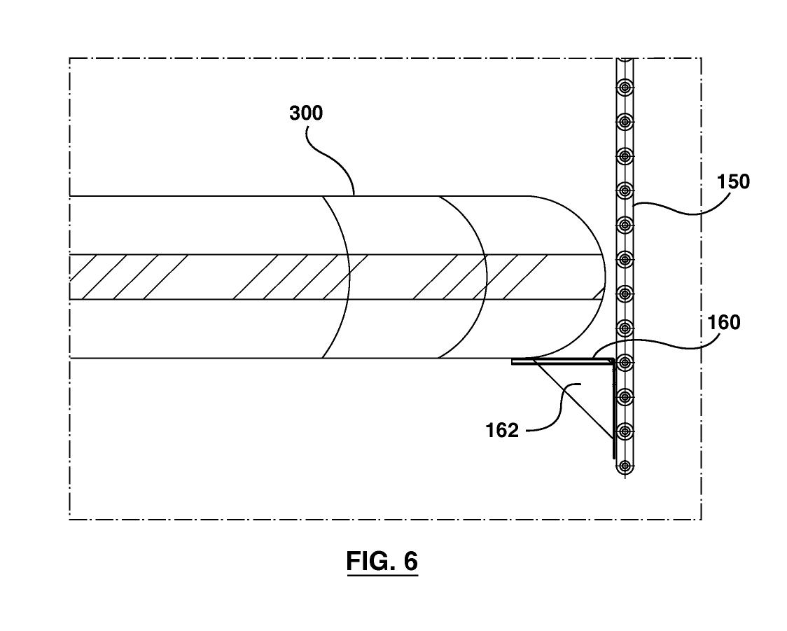

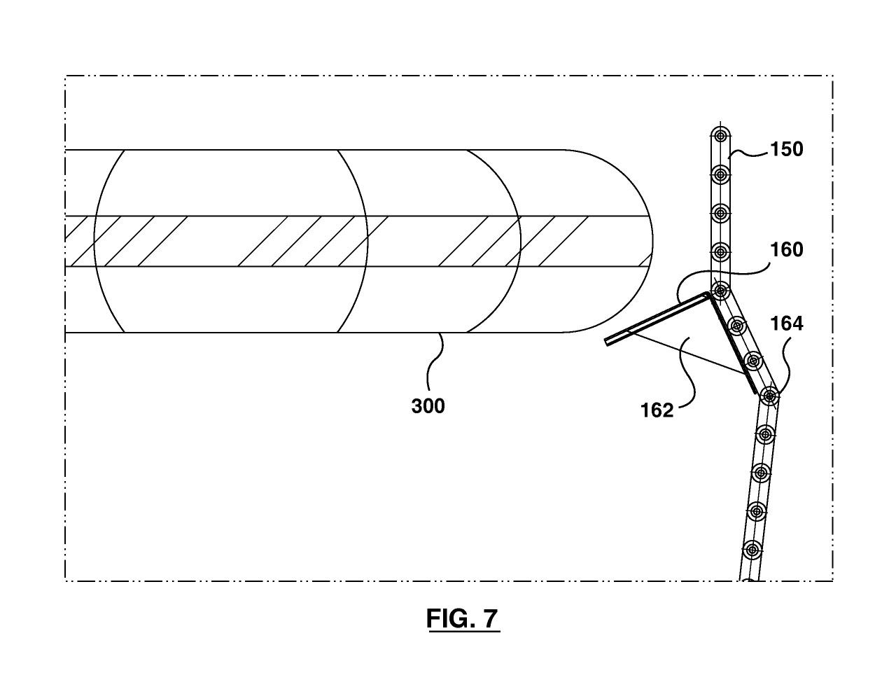

Referring now to FIGS. 6-7, there is shown an alternate embodiment of the flight 160 is shown. In FIG. 6, the band 150 has a flight 160 with a horizontal support surfafe mounted to it supporting a raft 300. The flight 160 comprises a gusset 162 that is also attached to the belt 150 at a lower point so as to maintain the flight's 160 upper surface in an essentially horizontal position during normal operation. There are a plurality of flights 160 and their corresponding gussets 162 mounted to each of the bands 150 so as to provide multiple lift points for handling the raft 300. FIG. 7 shows the effect of a jam in the lifting operation. If the upward motion of the raft 300 is blocked the drive 200 continues to move the band 150 past the stationary raft 300. To prevent damage, the flight 160 and its supporting gusset 162 are deflected past the stationary raft 300. The band 150 deflects outward as shown in FIG. 7 at 164 and this consequently raises the band 150, which is enabled by the vertical freedom of the tensioner 600 beneath. The tensioning weight 610 is selected so that in normal operation the flights 160 will support the weight of the raft 300 without deflecting the band 150, but when a jam occurs the gravitational force on the weight 610 is overcome to allow the deflection of the flight 160 past the raft 300 without causing damage. Once the jam is cleared the tensioner 600 returns the band 150 to its normal vertical configuration automatically so the normal lifting operation can continue.

The whole delivery sequence, including the loading of the rafts 300, is preferentially monitored and controlled ensuring proper operation and speed of delivery to the top 124 of the tower 120. Control and monitoring is achieve by the use of at least one controller (not shown) coupled in signal communication with one or more drives 200, the controller also being in signal communication with one or more sensors (also not shown). The controller is adapted to selectively control the speed and/or power output of the one or more drives 200. The sensors may be of a type and located and configured to monitor multiple aspect of the operation of the vertical conveyor 100 such as the speed of the bands 150, the presence of rafts 300 at the entrance and/or exit points of the vertical conveyor 100, the presence of any jams, or malfunctions in the operation of the vertical conveyor. In addition, the controller may be adapted for manual control by a ride operator. A few suitable examples of sensors may be infrared motion detectors, mechanical switches, or optical sensors, etc.

When using an electric drive 200 equipped with Variable Frequency Drives (VFD) with current monitoring, the controller may detect a rise in current if there is a jam. If the jam is severe then the controller may be adapted to detect this and reverse the drives 200. The controller may be programmed to reverse the drive 200 at a predetermined current to help clear the jam and prevent damage to the rafts 300 or the vertical conveyor 100. Similarly if a hydraulic drive 200 is used, a torque monitoring device senses a rise in torque should a jam occur and the controller may reverse the drive 200 to help clear the jam and prevent damage.

The controller may also be configured to signal operators of the status of the vertical conveyor. It is typical that ride attendants at the top and bottom of the vertical conveyor 100 may not be in direct visual or audible contact. Therefore the controller may be used to convey information regarding the presence or absence of rafts 300 etc. Signaling may be by any conventional form such as warning lights, buzzers or even the operation of physical barriers configured to block the overloading of the vertical conveyor 100. Optical sensors may be used for example to control the loading and unloading of the rafts 300. If the controller detects that a raft 300 is reaching the unloading stage at the top of the tower 120 and the delivery tray 126 is not clear of a raft 300, the controller may slow the one or more drives 200 and therefore bands 150 to a reduced speed. If there is an emergency or the vertical conveyor 100 is full, the controller will stop the vertical conveyor 100 and will not allow operations to be restarted until the situation is resolved. The controller may be configured and adjusted to ensure the rafts 300 are delivered at an optimal rate by eliminating unnecessary starts and stops.

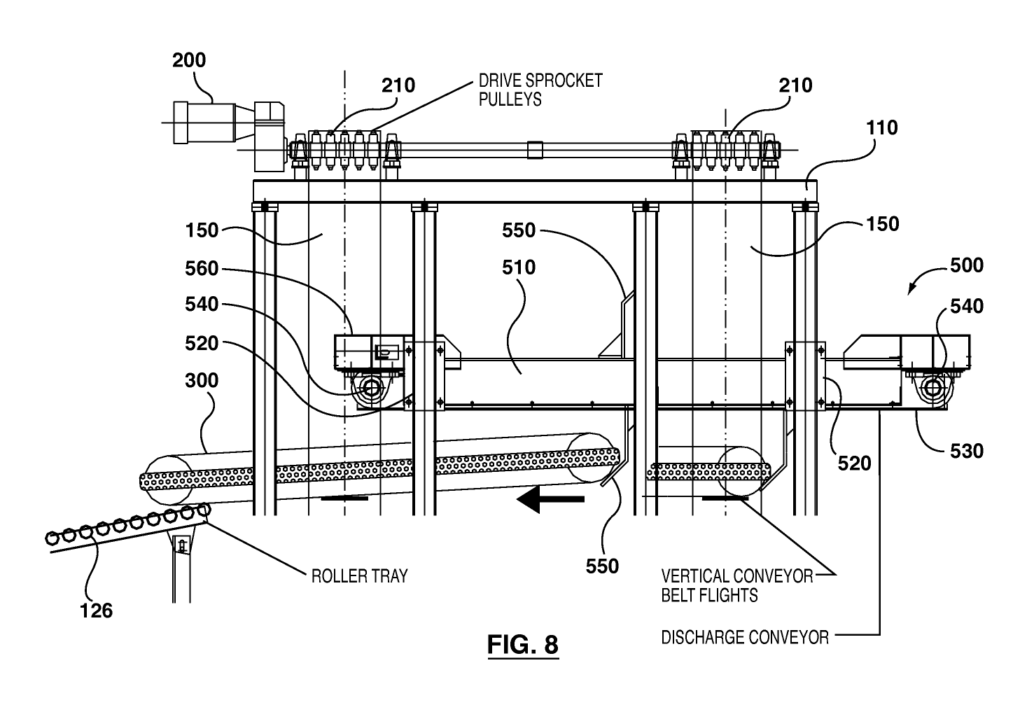

Referring now to FIG. 8, there is shown a detail view of an unloader 500 in accordance with the present invention. The unloader 500 comprises a frame 510 having a plurality of mounts 520 for securing the unloader 500 to the metal structure 110. Connected to the frame 510 are two rollers 540, at least one of which is driven by an unloader motor 560. If a controller is employed, the unloader motor may advantageously be in signal communication with the controller. Disposed around the rollers 540, there is an unloader conveyor 530 that is oriented in a substantially horizontal plane. The unloader conveyor comprises at least one unloader vane 550 for engaging and transferring a raft 300 from the vertical conveyor 100 to the top 124 of the tower 120. The egress of the raft 300 may optionally be to a delivery tray 126. In operation, the unloader conveyor 530 cycles either independently, or in a manner coordinated with the vertical conveyor 100. In the preferred embodiment, the one or more unloader vanes 550 lifts the trailing edge of the raft 300 and slides the raft 300 off the flights 160 onto the receiving delivery tray 126, which directs the rafts 300 to the start of the ride.

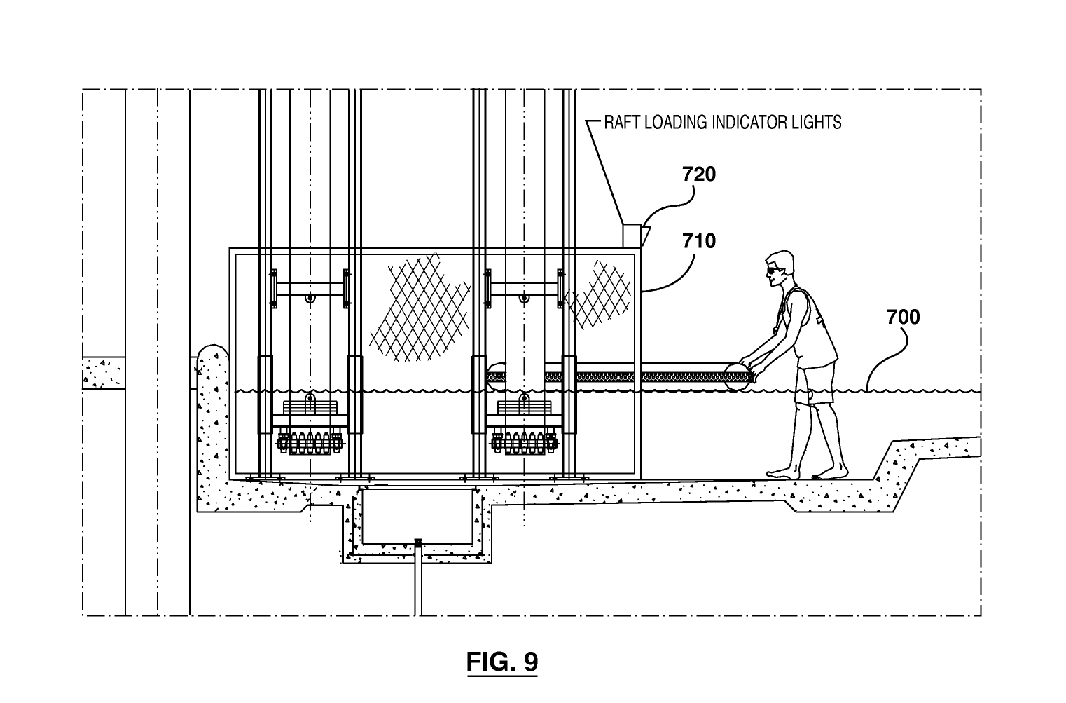

Turning now to the loading of the vertical conveyor 100, the loading of the objects, such as the rafts 300, onto the vertical conveyer 100 is generally easy to achieve, for example manually or by the use of mechanical guides, water jets, currents, etc. Referring to FIG. 9, there is shown a first embodiment for the loading of rafts 300 whereby each raft is directed into the vertical conveyor 100 manually. The transfer is aided by the lowest portion of the vertical conveyor 100 being situated below water level 700 so that the raft 300 may be floated into position for engagement with the flights 160 with minimal force required from the ride attendant. Suitable safety features such as guards 710 may be configured to protect riders and attendants from harm. For illustration, an example of a signal device 720 is shown. This signal device 720 may be a light or some other indicator that communicates the status of the vertical conveyor 100 to the attendant. Alternately, there may be provided a physical barrier allowing rafts 300 to only be loaded when the flights 160 are in an appropriate position to receive a raft 300. Optionally, any signal device employed may be controlled and in signal communication with the controller.

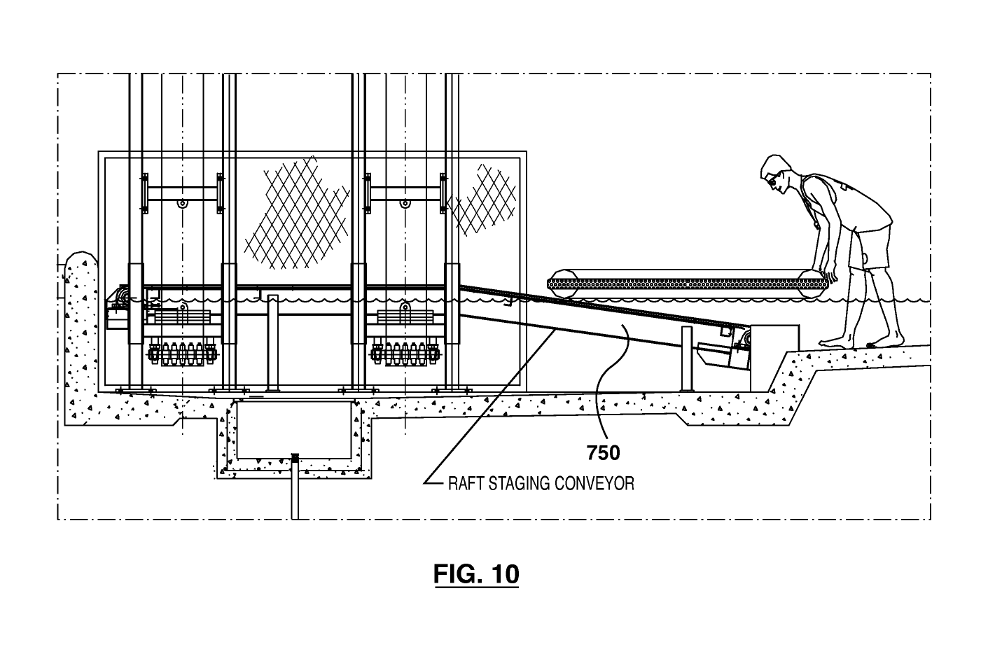

An alternate embodiment for loading the vertical conveyor 100 is shown in FIG. 10 where a loading conveyor assembly 750 assists with the mechanical transfer of rafts 300 into the vertical conveyor 100. This embodiment has the advantage that is may be adapted to be in signal communication with a controller so that the rafts 300 may be loaded automatically, preferably from a queue of rafts 300 positioned for engagement by the loading conveyor assembly 750, thereby enabling an optimal loading rate for the rafts 300. Further alternate mechanically assisted means for loading the vertical conveyor 100 (not shown) may include feeders or tiling devices generally known in the art of waterslide design. The speed and the sequencing for loading and unloading the rafts may be adjustable and calibrated to reach an optimum cycle time for the local waterpark conditions.

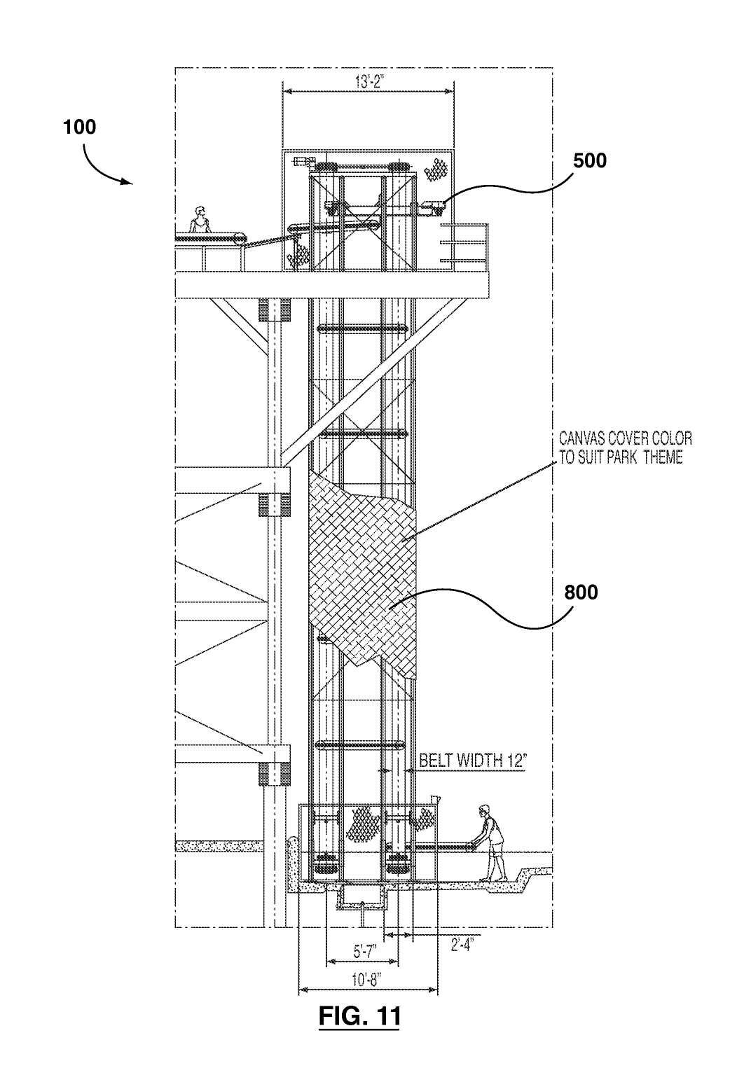

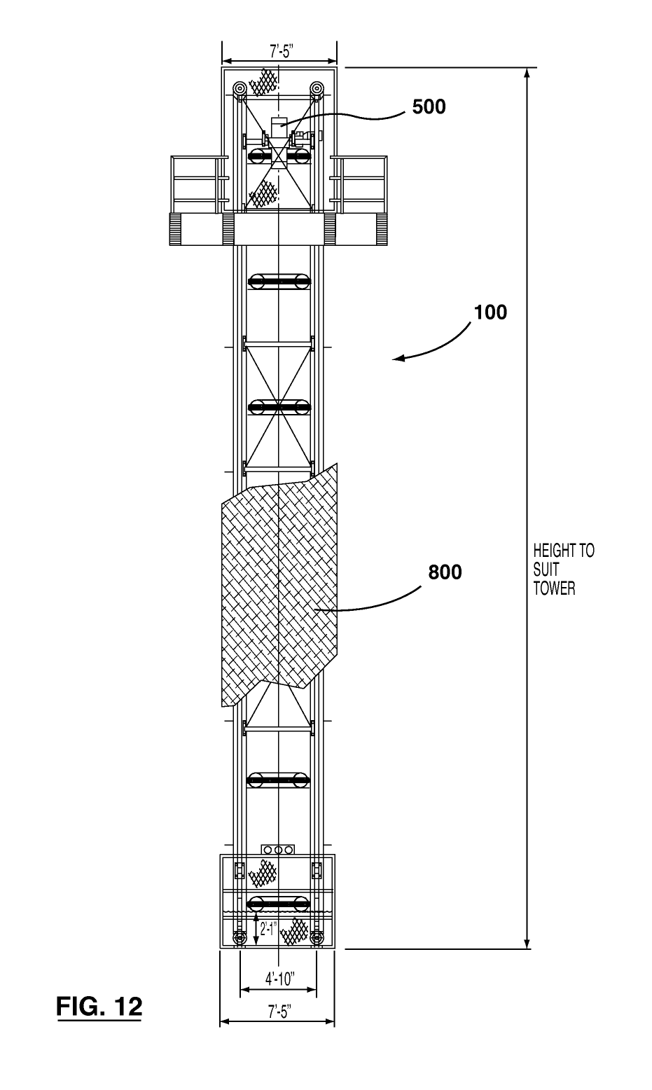

In a further embodiment of the present invention, reference can be made to FIGS. 11-12 which illustrate a vertical conveyor further comprising a cover 800. The cover 800 may partially or substantially fully encapsulate the vertical conveyor 100. Such a cover 800 may be composed of any suitable material, including soft covers made of materials such as canvas or nylon, or hard covers made of materials such as plastic or aluminum. In addition to providing an improved protection, a cover 800 provides a surface that may carry advertising or graphic elements to further enhance the waterslide's appearance.

It should be apparent to those skilled in the art that this represents an illustrative, non-limiting example only and that other arrangements are suitable for use with the present invention. One suitable example of an alternate configuration of a conveyor system includes a conveyor system having any combination of two or more types of conveyor assemblies, disposed in any order relative to one another, and having any number of quantities of conveyor assemblies. A second suitable example of an alternate configuration of a conveyor system includes a conveyor system having any quantity, including one, of only one type of conveyor assembly.

Modifications, changes or alternate structures may be employed from the specific forms of the invention herein shown as typical examples will occur to those skilled in the art. All such modifications and changes, not departing from the spirit of invention, are intended to be embraced within the scope of the appended claims. Changes in detail or structure may be made without departing from the spirit of the invention as defined in the appended claims. In addition, although specific rates, speeds, and distances are described herein for illustrative purposes, those skilled in the art should appreciate that other rates, speeds, and distances are suitable for use with the present invention.

All directional references (e.g., upper, lower, upward, downward, left, right, leftward, rightward, top, bottom, above, below, vertical, horizontal, clockwise, and counterclockwise), are only used for identification purposes to aid the reader's understanding of the embodiments of the present invention, and do not create limitations, particularly as to the position, orientation, or use of the invention unless explicitly set forth in the claims. Connection references (e.g., attached, coupled, connected, joined, and the like) are to be construed broadly and may include intermediate members between a connection of elements and relative movement between elements. As such, unless explicitly claimed, connection references do not necessarily infer that two elements are directly connected and in fixed relation to each other.

1. A vertical conveyor for lifting a raft comprising
a drive; and
a plurality of bands connected to the drive for synchronous vertical movement, each of the plurality of bands having a plurality of flights;
wherein the plurality of bands are spaced apart and oriented so that at least one flight on each of the plurality of bands is oriented to demountably engage with the raft; and
wherein the raft is maintained substantially horizontal throughout its vertical travel path.

2. The vertical conveyor of claim 1 wherein the flights are integral to the band.

3. The vertical conveyor of claim 1 wherein the flights are rigid.

4. The vertical conveyor of claim 1 wherein the flights are configured to pivotably release the raft in the event of a jam.

5. The vertical conveyor of claim 1 further comprising
an unloader aligned with the vertical conveyor for horizontal translation of the raft at end of its vertical travel path.

6. The vertical conveyor of claim 1 further comprising
a controller in signal communication with the drive; and
at least one sensor in signal communication with the controller,
wherein the at least one sensor is configured to detect the presence or absence of the raft proximate the at least one sensor's location; and
wherein the controller is configured to alter the speed of the drive depending on input from the sensor.

7. The vertical conveyor of claim 6 wherein
the drive is reversible and the controller is configured to change the direction of the drive depending on the input from the sensor.

8. The vertical conveyor of claim 1 further comprising
one or more tensioners connected to the band comprising a weight operating under the force of gravity.

9. The vertical conveyor of claim 8 wherein the one or more tensioners are configured to permit temporary vertical deflection of one or more of the plurality of bands.
